(19) United States
(12) Patent Application Publication
(10) Pub. No.: US 2012/0246332 A1
(43) Pub. Date: Sep. 27, 2012

(54) CIRCULAR BUFFER AND METHOD FOR MULTIMEDIA STREAMING SERVICE BASED PEER-TO-PEER

(75) Inventors: Chang Kyu LEE, Daejeon (KR); Sung Hei KIM, Daejeon (KR); Wook HYUN, Daejeon (KR); Shin Gak KANG, Daejeon (KR)

(73) Assignee: Electronics and Telecommunications Research Institute, Daejeon (KR)

(21) Appl. No.: 13/427,746

(22) Filed: Mar. 22, 2012

(30) Foreign Application Priority Data
Mar. 23, 2011 (KR) 10-2011-0025715

(51) Int. Cl. G06F 15/16

(52) U.S. Cl. 709/231

(57) ABSTRACT

The present invention relates to use of a circular buffer used by a peer in a multimedia streaming service based on peer-to-peer (P2P), and an operating method thereof. A circular buffer of the present invention may include a buffering section to process a delayed data fragment transmission request from at least one peer present in a network according to a playback of a multimedia content, a storing section to store data to be provided to the at least one peer, a continuous storing section in which data fragments for the playback of the multimedia content are stored in serial order, and a discontinuous storing section in which a space for a received data fragment to be shared with the at least one peer is reserved and a space for a data fragment to be received is reserved.

### CROSS-REFERENCE TO RELATED APPLICATION

This application claims the benefit of Korean Patent Application No. 10-2011-0025715, filed on Mar. 23, 2011, in the Korean Intellectual Property Office, the disclosure of which is incorporated herein by reference.

### BACKGROUND

1. Field of the Invention

The present invention relates to use of a circular buffer used by peers in a multimedia streaming service based on peer-to-peer (P2P), and an operating method thereof.

2. Description of the Related Art

Unlike a server-client scheme, a peer-to-peer (P2P) scheme may have a merit of providing scalability. While the server-client scheme may involve a degraded quality of service to all clients, due to an increased server load resulting from an increased number of clients, the P2P scheme based on a small amount of communication with a server and communication between clients referred to as peers, may not involve a degraded quality of service, and may result in an enhanced quality of service according to the occasion. Due to scalability, the number of service providers using the P2P scheme in the provision of a real-time multimedia streaming service is gradually increasing.

Unlike a video on demand (VOD) service based on a server, the real-time multimedia streaming service provided through the P2P scheme may divide a single piece of content into several data fragments, and may use an active data exchange between peers. Thus, a streaming server that generates real-time multimedia streaming content may generate content, divide the content into several data fragments having unique identifications (IDs), and transmit the data fragments to other peers. Peers received the data fragment from other peer, in turn, may transmit data fragments to other peers, thereby distributing streaming data to an overall P2P network.

A conventional real-time multimedia streaming service based on P2P may generate a temporary file on a local disk, and continuously write received data in the temporary file. Thus, the file size of a disk space may continuously increase as a service progresses, and the size of information related to stored data fragments exchanged to share data between peers may also increase.

### SUMMARY

An aspect of the present invention provides a circular buffer for a multimedia streaming service based on a peer-to-peer, and an operating method thereof that may minimize a load in a peer-to-peer (P2P) network using the circular buffer.

Another aspect of the present invention also provides a circular buffer for a multimedia streaming service based on a peer-to-peer, and an operating method thereof that may minimize, using the circular buffer, a storage space used for the multimedia streaming service.

According to an aspect of the present invention, there is provided a circular buffer for a multimedia streaming service based on a peer-to-peer, the circular buffer including a buffering section to process a delayed data fragment transmission request from at least one peer present in a network according to a playback of a multimedia content, a storing section to store data to be provided to the at least one peer, a continuous storing section in which data fragments for the playback of the multimedia content are stored in serial order, and a discontinuous storing section in which a space for a received data fragment to be shared with the at least one peer is reserved and a space for a data fragment to be received is reserved.

The buffering section may be located between an ending point of the discontinuous storing section and a starting point of the storing section.

A length of the buffering section and a length of the storing section may be defined, by a system parameter, according to a bit rate of the multimedia content.

The storing section may be located between an ending point of the buffering section and a playback position corresponding to a position at which data of a buffer is used to output content.

The continuous storing section may be set to an area starting from a playback position at which data of a buffer is read to output content, to a position of a final data fragment continuously connected to a data fragment at the playback position.

Data present in the continuous storing section may be transmittable to the at least one peer present in the network.

The discontinuous storing section may be set to an area starting from a point at which a first non-storing data fragment is generated in a playback direction, to a point before the buffering section starts.

An area of one of the buffering section, the storing section, the continuous storing section, and the discontinuous storing section may be moved, simultaneously, according to a reception of the data fragment.

Information about storing the data fragment may include information about an identification (ID) of a data fragment referred to by a playback position, a length of the continuous storing section in an integer form, a length of the discontinuous storing section in an integer form, a buffer map of the discontinuous storing section, and a length of the storing section in an integer form.

The buffer map of the discontinuous storing section may indicate whether each data fragment is included by use of a bit “0” or a bit “1.”

According to another aspect of the present invention, there is provided an operating method for a multimedia streaming service based on a peer-to-peer, the method including requesting, from at least one peer included in a peer-to-peer network, information about stored data fragments, receiving, from the at least one peer, the information about stored data fragments, requesting a data fragment to be used with reference to the received information, and receiving the data fragment being requested.

The requesting of the data fragment to be used may include requesting the data fragment to be used along with information about an ID of the data fragment to be used, a block number of starting data, and a number of data blocks requested to be transmitted.

When the data fragment to be used is received from the at least one peer, the data fragment to be used may include an ID of the data fragment, the number of starting data block, the number of ending data block, and a data block.

Verifying whether the data fragment to be used is present may correspond to identifying a data fragment included in a storing/continuous storing section in the information about stored data fragments received from the at least one peer.

According to still another aspect of the present invention, there is provided an operating method for a multimedia streaming service based on a peer-to-peer, the method including requesting, from at least one peer included in a peer-to-peer network, information about stored data fragments, receiving, from the at least one peer, the information about stored data fragments, determining whether a data fragment to be used is included in a storing/continuous storing section of the at least one peer with reference to the information about stored data fragments received from the at least one peer, performing a bit-and operation on a stored buffer map and a buffer map included in the received information about stored data fragments when the data fragment to be used is absent in storing section and continuous storing section, determining whether the data fragment to be used is included in the discontinuous storing section of the at least one peer as a result of the operation, and requesting the data fragment to be used when the data fragment to be used is included in the discontinuous storing section.

The bit-and operation may be performed after performing a bit-shift operation between the own buffer map and the received buffer map by referencing to a length of the continuous storing section and an ID of a data fragment referred to by a playback position.

According to yet another aspect of the present invention, there is provided an operating method for a multimedia streaming service based on a peer-to-peer, the method including changing a starting address of a continuous storing section from an address including an n^{th} fragment to an address including an n+1^{th} fragment in response to a playback position moving from a point in time t to a point in time t+1, according to a multimedia streaming service, changing a final address of a storing section to the starting address of the continuous storing section at the point in time t, according to the change of the starting address of the continuous storing section, and shifting a buffering section and a discontinuous storing section to correspond to a changed starting address of the storing section.

A length of the buffering section may be fixed, and a starting address of the buffering section may be changed in response to an ending address of the buffering section being changed.

According to an embodiment of the present invention, it is possible to reduce a size of information related to stored data fragments exchanged in a P2P network, and reduce an amount of the corresponding control traffic, using a minimum amount of memory or a minimum amount of local disk space in a conventional multimedia streaming service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of connections of a peer-to-peer (P2P) network for a multimedia streaming service according to embodiments of the present invention;

FIG. 2 is a block diagram illustrating a circular buffer according to embodiments of the present invention;

FIGS. 3A and 3B are diagrams illustrating a movement of each buffer section and a function of a buffering section according to a process of a multimedia streaming service according to embodiments of the present invention;

FIG. 4 is a diagram illustrating an example of a circular buffer of each peer receiving a real-time multimedia streaming service based on a P2P network according to embodiments of the present invention;

FIG. 5 is an operational flowchart illustrating communication between peers for data exchange in a real-time multimedia streaming service based on a P2P network according to embodiments of the present invention;

FIG. 6 is a flowchart illustrating an operation performed when information about stored data fragments is received in a real-time multimedia streaming service based on a P2P network according to embodiments of the present invention; and

FIG. 7 is a flowchart illustrating a section updating operation of a circular buffer with a progress of a multimedia streaming service according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

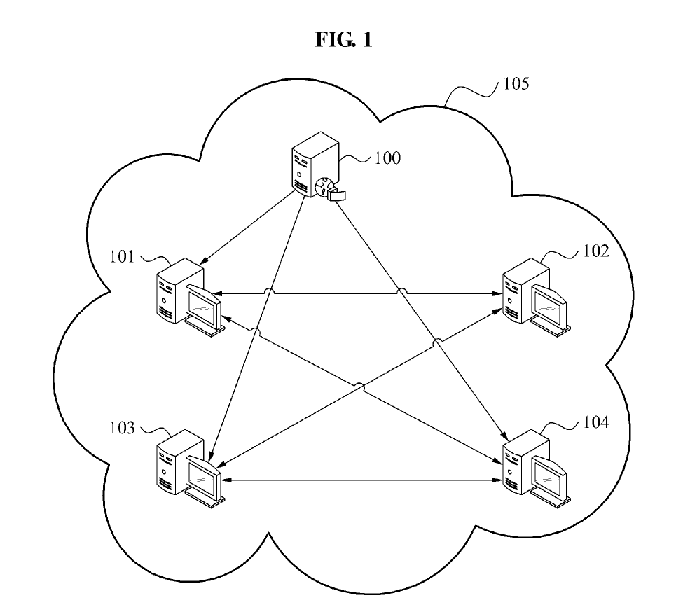

FIG. 1 is a diagram illustrating a configuration of connections of a peer-to-peer (P2P) network for a multimedia streaming service according to embodiments of the present invention.

Referring to FIG. 1, in a service according to embodiments of the present invention, a streaming server 100 and multiple peers, for example, peers 101, 102, 103, and 104 corresponding to service subscribers may construct a P2P network by being connected to each other over an Internet protocol (IP) network 105. The streaming server 100 may generate multimedia streaming content to deliver to service subscribers.

The peers 101, 102, 103, and 104 may basically perform a function of using the multimedia streaming content, or a function of providing received content data to another peer. A connection between a peer and the streaming server 100 or between peers may be newly generated or disconnected according to a data transmission operation.

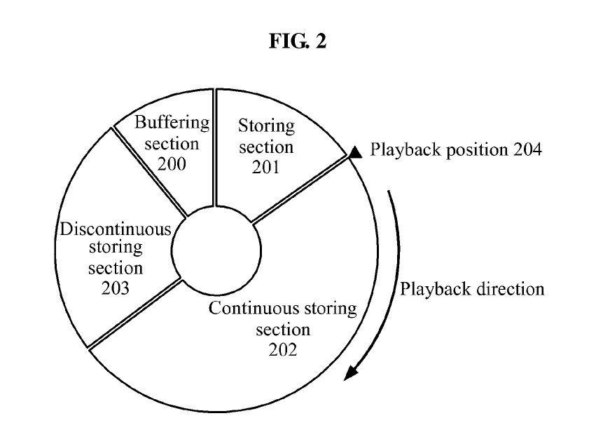

FIG. 2 is a block diagram illustrating a circular buffer according to embodiments of the present invention.

Referring to FIG. 2, a circular buffer according to embodiments of the present invention may be divided into a buffering section 200, a storing section 201, a continuous storing section 202, and a discontinuous storing section 203.

The buffering section 200 may correspond to a section for handling the request for a data fragment which is included in the storing section 201 when the request is sent but is belonged to buffering section 200 when the request is arrived as the storing section 201 moves. How much buffering section can handle the delayed request is dependent on the length of the buffering section 200. Information about the buffering section 200 may be excluded from information about stored data fragments informing another peer. The buffering section 200 may be located between an ending point of the discontinuous storing section 203 and a starting point of the storing section 201.

The storing section 201 may correspond to a space for storing data to provide data to another peer. That is, the storing section 201 may correspond to a space for temporarily storing data to be provided to another peer rather than data to be used for a media playback. The storing section 201 may be located between an ending point of the buffering section 200 and a playback position 204 corresponding to a position at which data of a buffer is used by a peer to view content. A length of the buffering section 200 and a length of the storing section 201 may be defined, by a system parameter, according to a bit rate of the content. A ratio of the length of the buffering section 200 and the length of the storing section 201 according to a bit rate of the content may not be limited.

The playback position 204 may indicate a position at which data of a buffer is used by a peer to view content.

All data fragments stored in the continuous storing section 202 is in serial order for smooth play back of content and may be provided to another peer. The continuous storing section 202 may be set to an area starting from the playback position 204 at which data of a buffer is read to output content, to a position of a final data fragment continuously connected to a data fragment at the playback position 204.

The discontinuous storing section 203 may be set to an area starting from a point at which the continuous storing section 202 ends, until reaching a point before the buffering section 200 starts. Here, the continuous storing section 202 may correspond to an area for a non-storing data fragment read first in a playback direction starting from the playback position 204, and may have a space for a received data fragment and a space for a data fragment to be received.

A peer may request another peer for a data fragment to be received so as to receive the data fragment. A stored data fragment may be provided to another peer. In response to receiving a data fragment, each area of the buffering section 200, the storing section 201, the continuous storing section 202, and the discontinuous storing section 203 may be adjusted, simultaneously.

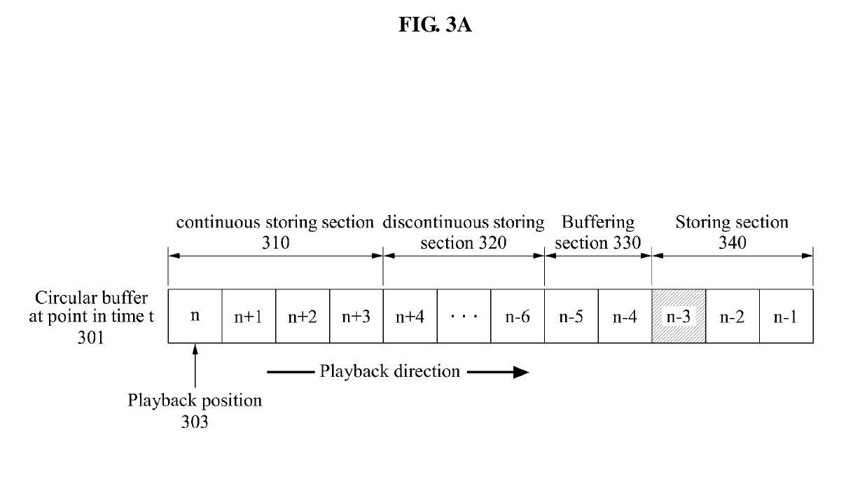

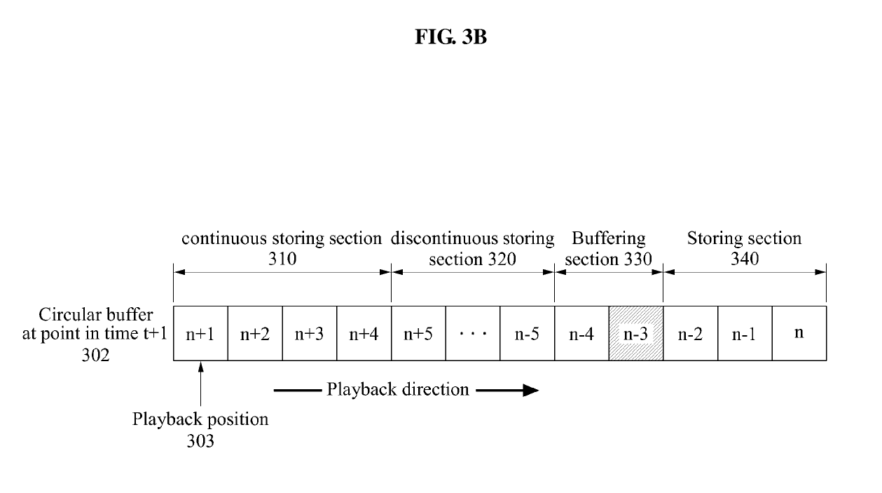

FIGS. 3A and 3B are diagrams illustrating a movement of each buffer section and a function of a buffering section according to a process of a multimedia streaming service according to embodiments of the present invention.

Referring to FIGS. 3A and 3B, a function of a buffering section according to a movement of each section included in a circular buffer according to embodiments of the present invention will be described. Each section of the circular buffer may move from FIG. 3A to FIG. 3B as a multimedia streaming service progresses.

A case in which a first peer having a circular buffer 301 transmits information about stored data fragments to another service subscriber (hereinafter, referred to as a second peer) as illustrated in FIG. 3A, and the first peer receives a request for transmission of an n−3^{th} data fragment from the second peer at a point in time t+1 as illustrated in FIG. 3B will be provided as a descriptive example.

The n−3^{th} data fragment may be absent from a storing section 340 of a circular buffer 302, but is included in a buffering section 330 in time t+1. Thus, the n−3^{th} data fragment can be transmittable. That is, the buffering section 330 may be used to accommodate the delayed request for transmitting data which have been moved to the buffering section 330, and may function as a buffer between the storing section 340 and a discontinuous storing section 320.

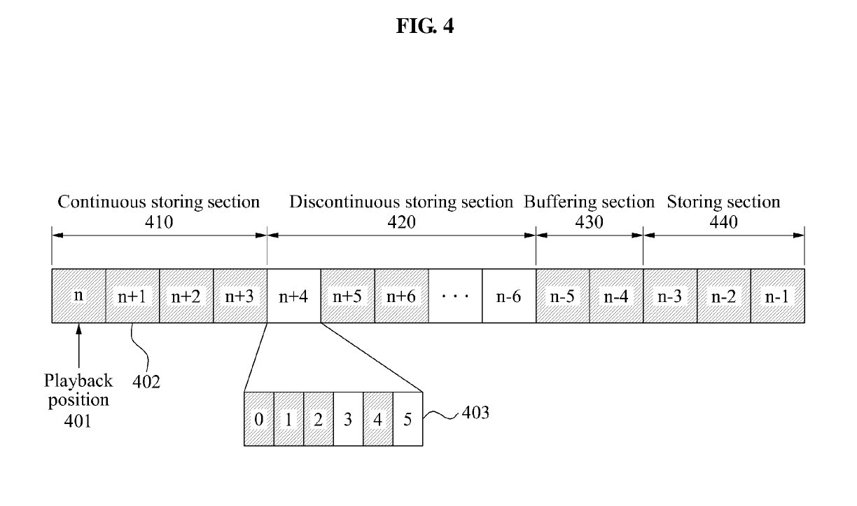

FIG. 4 is a diagram illustrating an example of a circular buffer of each peer receiving a real-time multimedia streaming service based on a P2P network according to embodiments of the present invention.

Referring to FIG. 4, it is presumed that an identification (ID) of a data fragment used at a current playback position 401 corresponds to “n”. An n^{th} data fragment through an n+3^{th} data fragment may be continuously stored in a buffer. Thus, a continuous storing section 410 may correspond to an area including the n^{th} through n+3^{th} data fragments. Each of a buffering section 430 and a storing section 440 may be set to an area corresponding to a size set by a system parameter according to a bit rate of content. The buffering section 430 may be set to store two data fragments, and the storing section 440 may be set to store three data fragments.

A discontinuous storing section 420 may have a space for a received data fragment and a space for a data fragment to be received. Referring to a state of an n+4^{th} data fragment 403 having a data block storing state, a third data block and a fifth data block may be not currently received and thus, reception of the n+4^{th} data fragment 403 may not be completed.

In response to the reception of the n+4^{th} data fragment 403 being completed, the continuous storing section 410 may be extended up to an area having an n+6^{th} data fragment. Thus, the discontinuous storing section 420 will be shrunk accordingly.

Although FIG. 4 illustrates a single data fragment composed six data blocks, this is merely provided as an example and a number of data blocks for each data fragment may not be limited thereto.

Information about stored data fragments exchanged between components included in a P2P network may include information about an ID of a data fragment referred to by the playback position 401, a length of the continuous storing section 410 expressed as an integer, a length of the discontinuous storing section 420 expressed as an integer, a buffer map of the discontinuous storing section 420, and a length of the storing section 440 expressed as an integer.

The information about an ID may correspond to an ID of a data fragment referred to by the playback position 401, that is, an ID of a first data fragment in the continuous storing section 410. As illustrated in FIG. 4, the ID of a data fragment referred to by the playback position 401 according to embodiments of the present invention may correspond to “n.” The information may be used as a base value for calculating a data fragment ID in another section of a circular buffer.

The length of the continuous storing section 410 in an integer form may correspond to “4” according to embodiments of the present invention. IDs of data fragments in the continuous storing section 410 may be calculated using the length of the continuous storing section 410 and an ID value of a data fragment referred to by the playback position 401.

The length of the discontinuous storing section 420, expressed as an integer, may be used as a reference for processing the buffer map since the length of the discontinuous storing section 420 is variable and thus, a length of the buffer map of the discontinuous storing section 420 is variable. The length of the discontinuous storing section 420 may be set to “0” when a received data fragment is absent from the discontinuous storing section 420.

The buffer map of the discontinuous storing section 420 may indicate whether each data fragment is included in the discontinuous storing section 420 by use of a bit “0” or a bit “1.” The buffer map according to embodiments of the present invention may have a value of “011 . . . 0.” When a received data fragment is absent in the discontinuous storing section 420, information about the buffer map of the discontinuous storing section 420 may be excluded from the information about stored data fragments.

The length of the storing section 440, expressed as an integer, may have a value set by a system parameter, which may correspond to “3” according to embodiments of the present invention. Thus, a peer receiving the information about stored data fragments may be informed that data fragments up to a data fragment having an ID, obtained by subtracting a maximum of 3 from an ID value referred to by the playback position 401, is included in a storing section of a peer that transmits the information about stored data fragments.

A message used for exchanging the information about stored data fragments between peers disclosed in embodiments of the present invention are exemplary and may not be limited thereby.

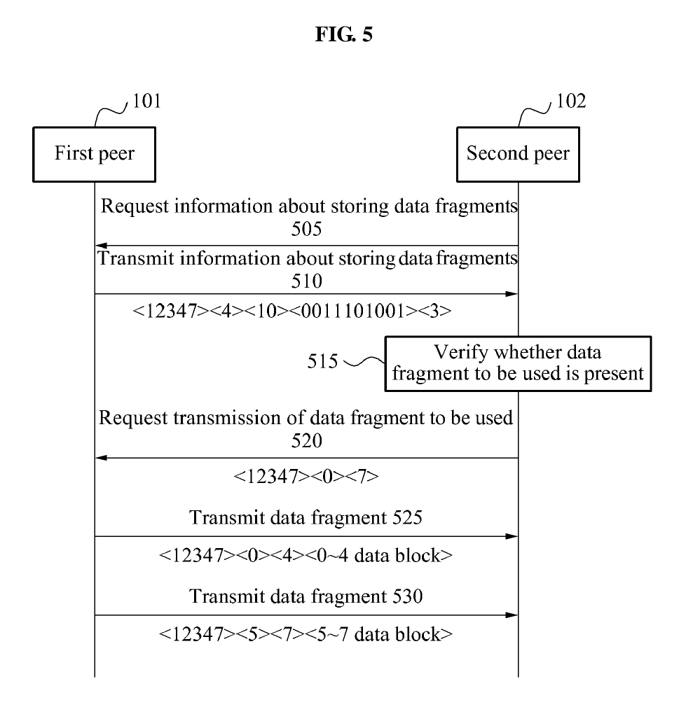

FIG. 5 is a diagram illustrating an operational flowchart illustrating communication between peers for a data exchange in a real-time multimedia streaming service based on a P2P network according to embodiments of the present invention.

Referring to FIG. 5, in operation 505, a second peer 102 may request another peer corresponding to an acquaintance (hereinafter, referred to as a first peer 101) for information about stored data fragments. In operation 510, in response to the request from the second peer 102, the first peer 101 may transmit information about stored data fragments of the first peer 101 to the second peer 102, in a scheme described with reference to FIG. 4.

In operation 515, the second peer 102 may compare information about stored data fragments of the second peer 102 with the received information, and verify whether the first peer has the data fragment to be used for the second peer 102. In operation 520, when the second peer 102 desires to get a “12347” data fragment included in the first peer 101, as a result of verification in operation 515, the second peer 102 may request transmission of the “12347” data fragment from the first peer 101.

In this instance, information to be provided may include additional information such as information about an ID of the data fragment to be used, the block number of starting data block, and a number of data blocks requested to be transmitted. The block number of starting data block may correspond to a block number of a first data block requested to be transmitted. The number of data blocks requested to be transmitted may correspond to a number of data blocks requested to be transmitted, including the first data block. Thus, an example of requesting seven data blocks from a 0^{th} data block of the “12347” data fragment is provided. However, the data fragment may not be divided into seven data blocks. Further, for a single request for transmission of a data fragment, a number of transmissions, depending on a size of a data block, may be performed for the data fragment when transmitting the data fragment.

When the requested data fragment is transmitted, the requested data fragment may be transmitted in a form of an ID of the data fragment, a block number of starting data block, a block number of ending data block, and data blocks. According to embodiments of the present invention, data blocks from the 0^{th} data block to a 4^{th} data block of the “12347” data fragment may be transmitted in operation 525, and then data blocks from a 5^{th} data block to a 7^{th} data block may be transmitted in operation 530.

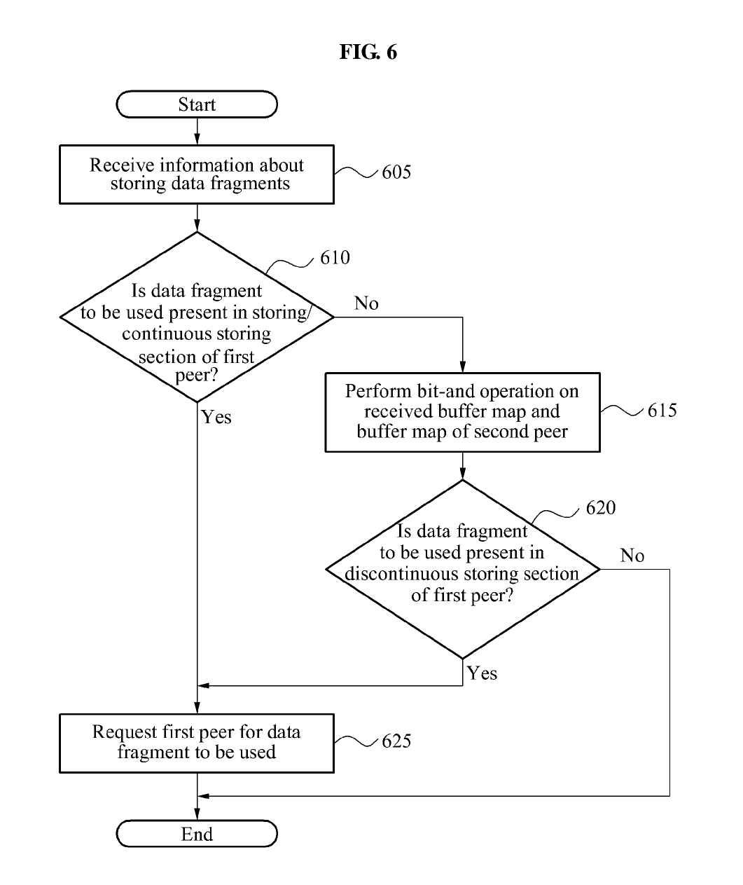

FIG. 6 is a flowchart illustrating an operation performed when receiving information about stored data fragments in a real-time multimedia streaming service based on a P2P network according to embodiments of the present invention.

In operation 605, information about stored data fragments may be requested and received between peers present in a network.

As illustrated in FIG. 5, the second peer 102 may determine whether a data fragment to be used is present in the storing/continuous storing section of the first peer 101 based on information about stored data fragments received from the first peer 101 in operation 610.

In operation 625, when the data fragment to be used is present in the storing/continuous storing section of the first peer 101 as a result of determination, the second peer 102 may request the corresponding data fragment from a data block to be used, and terminate a procedure.

In operation 615, when the data fragment to be used is absent in the storing/continuous storing section of the first peer 101, the second peer 102 may perform a bit-and operation on a buffer map of a discontinuous storing section of the second peer 102 and a buffer map of a discontinuous storing section in the received information about stored data fragments.

An ID of a data fragment corresponding to a start of a buffer map of a discontinuous storing section may differ between the first peer 101 and the second peer 102. Thus, a bit-shift operation may be performed on the buffer map of the discontinuous storing section with reference to a length of the continuous storing section and an ID of a data fragment referred to by a playback position. Thereafter, a bit-and operation may be performed after matching starting data fragment ID of the buffer map of the discontinuous storing section of the first peer 101 and the second peer 102.

In operation 620, the second peer 102 may verify whether a data fragment to be used for the second peer 102 is present in the discontinuous storing section of the first peer 101 after performing the bit-and operation. In operation 625, when the data fragment to be used is present as a result of verification, the second peer 102 may request the first peer for the data fragment.

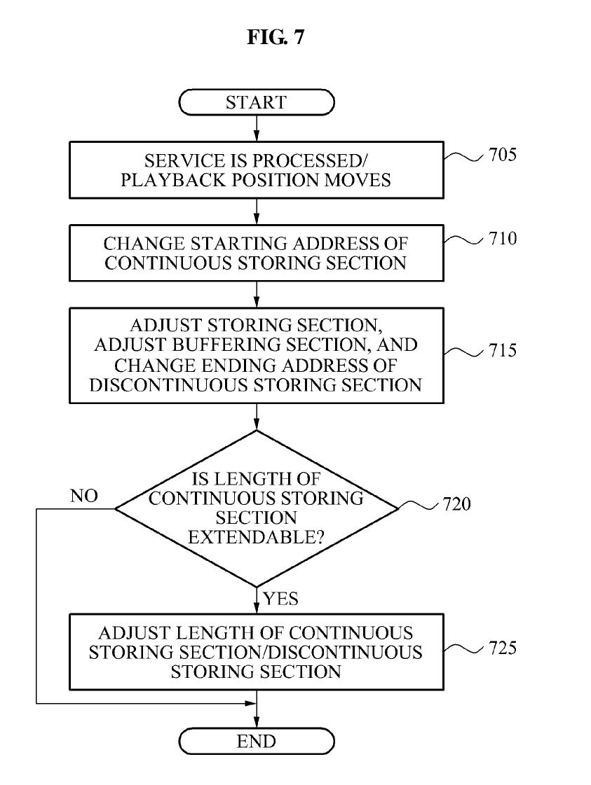

FIG. 7 is a flowchart illustrating a section updating operation of a circular buffer with a progress of a multimedia streaming service according to embodiments of the present invention.

In response to a playback position being moved with a progress of a multimedia streaming service in operation 705, a starting address of a continuous storing section may change in operation 710 since the starting address of the continuous storing section may match the playback position.

Referring to FIG. 3, a starting address of the continuous storing section 310 may be changed from an address of a space where an n^{th} data fragment is present at a point in time t to an address of a space where an n+1^{th} data fragment is present at a point in time t+1.

In operation 715, the storing section 340 may be adjusted. An ending address of the storing section 340 may correspond to a previous playback position, and a starting address may move accordingly. Referring to FIG. 3, an area of the storing section 340 may move from a space of an area [n−3, n−1] at a point in time t to a space of an area [n−2, n] at a point in time t+1.

An ending address of the buffering section 330 may change since the starting address of the storing section 340 may change. Referring to FIG. 3, the ending address of the buffering section 330 may change from an address of a space having an n−4^{th} data fragment to an address of a space having an n−3^{th} data fragment. Since a length of the buffering section 330 may be set, a starting address of the buffering section 330 may change in response to the ending address of the buffering section 330 being changed. Further, in operation 715, an ending address of the discontinuous storing section 320 connected to the buffering section 330 may change.

For example, changing of a length of the continuous storing section 310 may be determined based on a movement of the playback position 303 or based on whether a first data fragment of the discontinuous storing section 320 from the continuous storing section 310 (an n+4^{th} data fragment in FIG. 4) is received. When the corresponding data fragment is received, an ending address of the continuous storing section 310 may be moved. Referring to FIG. 4, the ending address of the continuous storing section 310 may change from an address of a space having an n+3^{th} data fragment to an address of a space having an n+6^{th} data fragment if n+3^{th} data fragment is received completely.

In operation 725, a starting address of the discontinuous storing section 320 may be changed according to the changed continuous storing section 310.

According to embodiments of the present invention, adjusting of each section is successively illustrated in FIG. 7. However, since adjusting of each section may be performed simultaneously, an order differing from that illustrated in FIG. 7 may be implemented.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A circular buffer for a multimedia streaming service based on a peer-to-peer (P2P), the circular buffer comprising:
a buffering section to process a delayed data fragment transmission request from at least one peer present in a network according to a playback of a multimedia content;
a storing section to store data to be provided to the at least one peer;
a continuous storing section in which data fragments for the playback of the multimedia content are stored in serial order; and
a discontinuous storing section in which a space for a received data fragment to be shared with the at least one peer is reserved and a space for a data fragment to be received is reserved.

2. The circular buffer of claim 1, wherein the buffering section is located between an ending point of the discontinuous storing section and a starting point of the storing section.

3. The circular buffer of claim 1, wherein a length of the buffering section and a length of the storing section are defined, by a system parameter, according to a bit rate of the multimedia content.

4. The circular buffer of claim 1, wherein the storing section is located between an ending point of the buffering section and a playback position corresponding to a position at which data of a buffer is used to output content.

5. The circular buffer of claim 1, wherein the continuous storing section is set to an area starting from a playback position at which data of a buffer is read to output content, to a position of a final data fragment continuously connected to a data fragment at the playback position.

6. The circular buffer of claim 5, wherein data present in the continuous storing section is transmittable to the at least one peer present in the network.

7. The circular buffer of claim 1, wherein the discontinuous storing section is set to an area starting from a point at which a first non-storing data fragment is generated in a playback direction, to a point before the buffering section starts.

8. The circular buffer of claim 1, wherein an area of one of the buffering section, the storing section, the continuous storing section, and the discontinuous storing section is moved, simultaneously, according to a reception of the data fragment.

9. The circular buffer of claim 1, wherein information about storing the data fragment comprises information about an identification (ID) of a data fragment referred to by a playback position, a length of the continuous storing section expressed as an integer, a length of the discontinuous storing section in an integer form, a buffer map of the discontinuous storing section, and a length of the storing section in an integer form.

10. The circular buffer of claim 9, wherein the buffer map of the discontinuous storing section indicates whether each data fragment is included by use of a bit “0” or a bit “1.”

11. An operating method for a multimedia streaming service based on a peer-to-peer (P2P), the method comprising:
requesting, from at least one peer included in a P2P network, information about stored data fragments;
receiving, from the at least one peer, the information about stored data fragments;
requesting a data fragment to be used with reference to the received information; and
receiving the data fragment being requested.

12. The operating method of claim 11, wherein the requesting of the data fragment to be used comprises requesting the data fragment to be used along with information about an identification (ID) of the data fragment to be used, a block number of starting data, and a number of data blocks requested.

13. The operating method of claim 11, wherein, when the data fragment to be used is received from the at least one peer, the data fragment to be used comprises an ID of the data fragment, a block number of starting data, a block number of ending data, and a data block.

14. The operating method of claim 11, wherein verifying whether the data fragment to be used is present corresponds to identifying a data fragment included in a storing/continuous storing section in the information about stored data fragments received from the at least one peer.

15. An operating method for a multimedia streaming service based on a peer-to-peer (P2P), the method comprising:
requesting, from at least one peer included in a P2P network, information about stored data fragments;
receiving, from the at least one peer, the information about stored data fragments;
determining whether a data fragment to be used is included in a storing/continuous storing section of the at least one peer with reference to the information about stored data fragments received from the at least one peer;
performing a bit-and operation on a stored buffer map and a buffer map included in the received information about stored data fragments when the data fragment to be used is absent;
determining whether the data fragment to be used is included in the discontinuous storing section of the at least one peer as a result of the operation; and
requesting the data fragment to be used when the data fragment to be used is included in the discontinuous storing section.

16. The operating method of claim 15, wherein the bit-and operation is performed after performing a bit-shift operation with reference to a length of the continuous storing section and an ID of a data fragment referred to by a playback position of a stored buffer map of the discontinuous storing section, and a buffer map of the discontinuous storing section that is received from the at least one peer.

17. An operating method for a multimedia streaming service based on a peer-to-peer (P2P), the method comprising:
changing a starting address of a continuous storing section from an address including an n^{th} fragment to an address including an n+1^{th} fragment in response to a playback position moving from a point in time t to a point in time t+1, according to a multimedia streaming service;
changing a final address of a storing section to the starting address of the continuous storing section at the point in time t, according to the change of the starting address of the continuous storing section; and
shifting and changing addresses of a buffering section and a discontinuous storing section to correspond to a changed starting address of the storing section.

18. The operating method of claim 17, wherein a length of the buffering section is fixed, and a starting address of the buffering section is changed in response to an ending address of the buffering section being changed.
